(19) United States
(12) Patent Application Publication
(10) Pub. No.: US 2018/0252155 A1
(43) Pub. Date: Sep. 6, 2018

(54) SELECTIVE CYCLE ENGINE WITH SIDEWALL VALVE

(71) Applicant: Smarthead Technologies, LLC, Portland, OR (US)

(72) Inventor: David Resnick, Portland, OR (US)

(73) Assignee: Smarthead Technologies, LLC, Portland, OR (US)

(21) Appl. No.: 15/911,673

(22) Filed: Mar. 5, 2018

Related U.S. Application Data
(60) Provisional application No. 62/466,916, filed on Mar. 3, 2017.

(51) Int. Cl. F02B 69/06; F02B 25/04

(52) U.S. Cl. CPC F02B 69/06; F02B 25/04

(57) ABSTRACT

A selective-cycle engine selectively operable in a 2-cycle mode and a 4-cycle mode, the selective-cycle engine including a cylinder including a head portion and a sidewall defining a cylinder interior, a piston driven in a reciprocating fashion within the cylinder interior, a head intake port and an exhaust port each defined in the head portion, a first sidewall intake port defined in the sidewall, an exhaust valve operable to open and close the exhaust port, a head intake valve operable to open and close the head intake port, and a first sidewall intake valve operable to open and close the first sidewall intake port. The head intake valve is maintained in a closed position to close the head intake port during 2-cycle mode while the first sidewall intake valve is opened and closed to provide intake air to the cylinder interior with opening and closing of the first sidewall intake valve being separately controlled from reciprocal movement of the piston.

### CROSS-REFERENCE TO RELATED APPLICATION

This application is a Non-Provisional of U.S. application Ser. No. 62/466,916, filed Mar. 3, 2018, entitled “SELECTIVE CYCLE ENGINE WITH SIDEWALL VALVE” which is herein incorporated by reference.

### BACKGROUND

Selective-cycle internal combustion engines are selectively operable in 4-cycle and 2-cycle modes. Conventional selective-cycles engines have not been commercially successful.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIGS. 1A and 1B are block and schematic diagrams generally illustrating a selective-cycle engine selectively operable between a 4-cycle mode and a 2-cycle mode, according to one example.

FIG. 2 is a block and schematic diagram generally illustrating a selective-cycle engine operating in 2-stroke mode, according to one example.

FIG. 3 is a schematic diagram generally illustrating intake valve positioning and corresponding intake air flows, according to one example.

FIGS. 4A-4D are block and schematic diagrams generally illustrating 2-stroke operation of a selective-cycle engine, according to one example.

FIG. 5 is a graph illustrating exhaust valve and sidewall intake valve timing and lift for a simulated 2-stroke operation of a selective-cycle engine, according to one example.

FIG. 6 is a graph illustrating engine pressure for a simulated 2-stroke operation of a selective cycle engine, according to one example.

FIG. 7A is a graph representing a contour map of “Brake Specific Fuel Consumption (BSFC)” for a simulated 2-stroke operation of a selective cycle engine, according to one example.

FIG. 7B is a graph representing a contour map of “Brake Torque” for a simulated 2-stroke operation of a selective cycle engine, according to one example.

FIG. 7C is a graph representing a contour map of “Trapping Ratio” for a simulated 2-stroke operation of a selective cycle engine, according to one example.

FIG. 7D is a graph representing a contour map of “Trapped Residuals” for a simulated 2-stroke operation of a selective cycle engine, according to one example.

FIG. 8 is a block and schematic diagram generally illustrating a selective-cycle engine operating in 2-stroke mode, according to one example.

FIG. 9 is a block and schematic diagram generally illustrating a selective-cycle engine operating in 2-stroke mode, according to one example.

FIGS. 10A-10D are block and schematic diagrams generally illustrating 2-stroke operation of a selective-cycle engine, according to one example.

FIG. 11 is a graph illustrating exhaust valve and sidewall intake valve timing and lift for a simulated 2-stroke operation of a selective-cycle engine, according to one example.

FIG. 12 is a graph illustrating engine pressure for a simulated 2-stroke operation of a selective cycle engine, according to one example.

FIG. 13A is a graph representing a contour map of “Brake Specific Fuel Consumption (BSFC)” for a simulated 2-stroke operation of a selective cycle engine, according to one example.

FIG. 13B is a graph representing a contour map of “Brake Torque” for a simulated 2-stroke operation of a selective cycle engine, according to one example.

FIG. 13C is a graph representing a contour map of “Trapping Ratio” for a simulated 2-stroke operation of a selective cycle engine, according to one example.

FIG. 13D is a graph representing a contour map of “Trapped Residuals” for a simulated 2-stroke operation of a selective cycle engine, according to one example.

FIG. 14 is a block and schematic diagram generally illustrating a selective-cycle engine operating in 2-stroke mode, according to one example.

FIG. 15A is a graph illustrating simulated intake and exhaust valve lift for 4-stroke Base and Miller operation of a 10% loaded selective-cycle engine, according to one example.

FIG. 15B is a graph illustrating simulated engine pressure for 4-stroke Base and Miller operation of a 10% loaded selective-cycle engine, according to one example.

FIG. 16A is a graph illustrating simulated intake and exhaust valve lift for 4-stroke Base and Miller operation of a 25% loaded selective-cycle engine, according to one example.

FIG. 16B is a graph illustrating simulated engine pressure for 4-stroke Base and Miller operation of a 25% loaded selective-cycle engine, according to one example.

FIG. 17A is a graph illustrating simulated intake and exhaust valve lift for 4-stroke Base and Miller operation of a 50% loaded selective-cycle engine, according to one example.

FIG. 17B is a graph illustrating simulated engine pressure for 4-stroke Base and Miller operation of a 50% loaded selective-cycle engine, according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

According to one example, in addition to employing intake and exhaust valves in the cylinder head, the present disclosure provides a selective-cycle internal combustion engine using one or more intake valves which are flush mounted in the sidewall of the cylinder and which are operable independently from piston operation. During 2-cylce operation, the head intake valve is inoperable, and the one or more sidewall valves are employed as fresh air intakes and provide uniflow scavenging of the cylinder. The sidewall intake valve(s) may be positioned at different locations on the cylinder sidewall (e.g., lower, middle, upper portions of the cylinder sidewall), and are independently operable from piston operation, so that intake and exhaust valve opening and closing times can be dynamically adjusted to enable improved efficiencies at all RPMs during 2-stroke operation.

As will be described in greater detail by examples illustrated herein, a selective-cycle engine employing sidewall intake valves, according to the present disclosure, enables spark-ignited and diesel engines to be downsized without increasing compression ratios, and enables spark ignited engines to employ compression ratios significantly higher than compression ratios of conventional spark ignited engines.

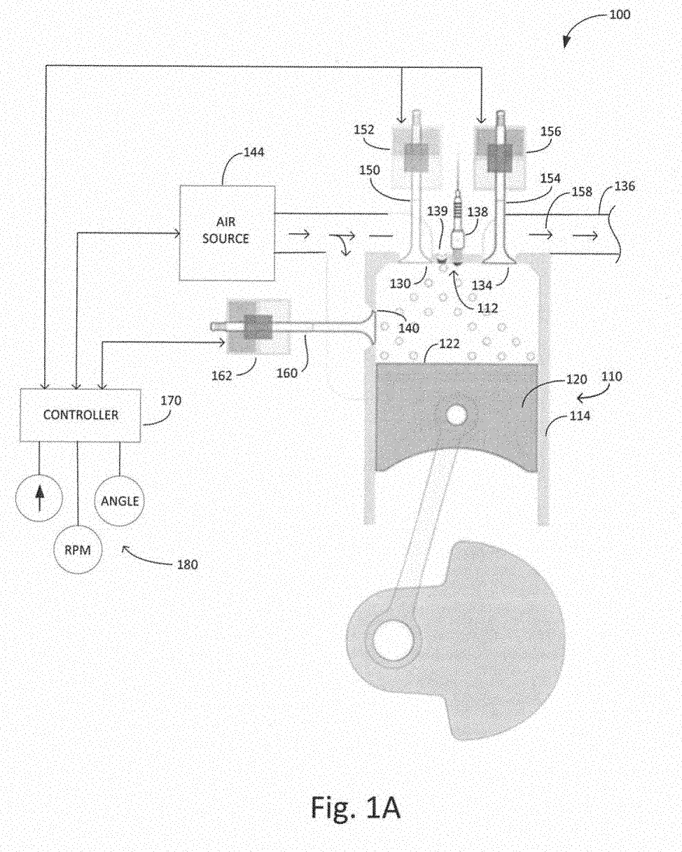

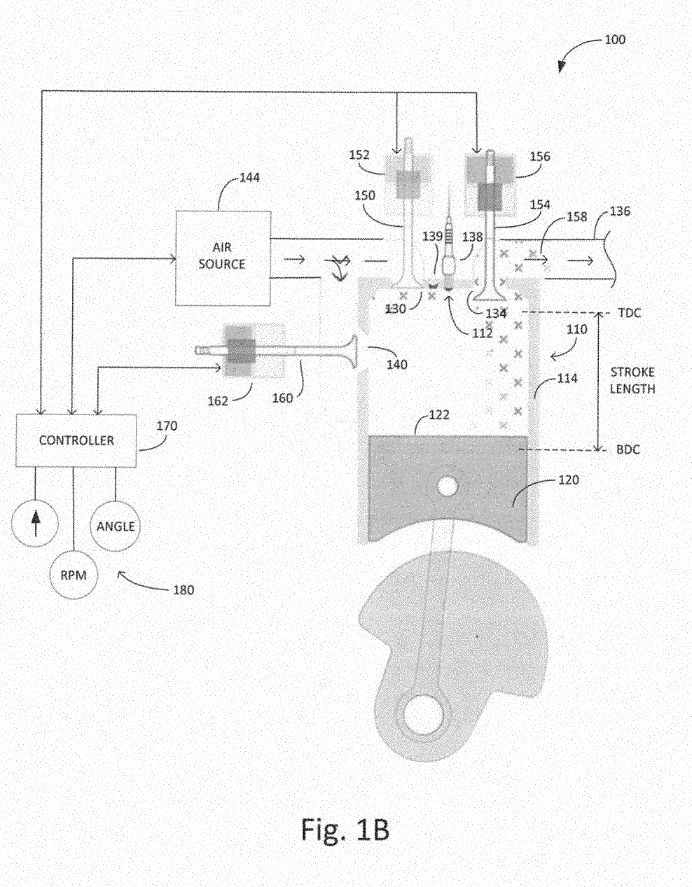

FIGS. 1A and 1B generally illustrate a selective-cycle engine 100 selectively operable between a 4-cycle mode and a 2-cycle mode, according to one example of the present disclosure. According to some examples, such as illustrated by FIGS. 1A and 1B, selective-cycle engine 100 may be configured as a spark-ignited (SI) engine. In other examples, selective-cycle engine 100 may be configured as a compression ignited (CI) or diesel engine.

According to one example, selective-cycle engine 100 includes a cylinder 110 having a head portion 112 and sidewalls 114 forming a cylinder interior 116 (e.g., a combustion chamber), with a piston 120 having a top surface 122 driven in a reciprocating fashion within cylinder interior 116. In one example, head portion 112 includes a head intake port 130 in communication with an intake air path 132, and an exhaust port 134 in communication with an exhaust air path 135. In one example, selective-cycle engine 100 further includes a sidewall intake port 140 defined in sidewall 114 which is in communication with intake air path 132. In one example, head portion 112 further includes an ignition mechanism 138 (e.g., a spark plug) and a fuel supply mechanism (e.g., a fuel injector).

An air source 144 provides pressurized intake air 146 to intake air path 132 for introduction into cylinder interior 116 via either head intake port 130 or sidewall intake port 140 depending on whether selective-cycle engine 100 is operating in 4-cycle mode or 2-cycle mode. In one example, air source 144 comprises a turbocharger. In other examples, air source 144 may comprise an electric turbocharger/supercharger or a pressurized air storage tank, for instance.

A head intake valve 150 is operable via a valve actuator 152 to move between an open position and a closed position so as to open and close head intake port 130 to control the supply of pressurized intake air 146 to cylinder interior 116 when selective-cycle engine 100 is operating in 4-cycle mode. An exhaust valve 154 is operable via a valve actuator 156 to move between an open position and a closed position so as to open and close exhaust port 134 to control the flow of exhaust air 158 from cylinder interior 116 when selective-cycle engine 100 is operating in either a 4-cycle mode or a 2-cycle mode. A sidewall intake valve 160 is operable via a valve actuator 162 to move between an open position and a closed position so as to open and close sidewall intake port 140 to control the supply of pressurized intake air 146 to cylinder interior 116 when selective-cycle engine 100 is operating in 2-cycle mode.

In one example, valve actuators 152, 156, and 162 are digitally controlled electromagnetic valve actuators. In other examples, valve actuators 152, 156, and 162 and digitally controlled hydraulic or pneumatic valve actuators. It is noted that any suitable type of digitally controlled valve actuators may be employed.

In one example, as illustrated by FIG. 1B, head intake valve 150 and exhaust valve 154 are poppet valves which are flush with the cylinder interior 116 of cylinder 110 when in the closed position, and which extend into the cylinder interior 116 when in the open position. In contrast, in one example, sidewall intake valve 160 comprises what is referred to herein as a “pop-up” valve which is flush with sidewall 114 on the interior 116 of cylinder 110 when in the closed position, and which is retracted away from cylinder interior 116 so as to be external or remote from the interior 116 of cylinder 110 when in the open position. Such operation ensures that there will be no interference between sidewall intake valve 160 and piston 120 during operating of selective-cycle engine 110, particularly during 2-cycle operation.

In one example, as illustrated, head intake valve 150 and sidewall intake valve 160 respectively comprise a poppet valve 150 and a pop-up valve 160. In other examples, as illustrated in other examples herein, head intake valve 150 and sidewall intake valve 160 may comprise pneumatic injectors, or some combination of pneumatic injectors and poppet and pop-up valves.

With reference to FIG. 1B, a controller 170 determines and controls the mode in which selective cycle engine 100 operates (4-cycle or 2-cycle) and switching there between, controls air source 144 and the pressure of supply air 146 provided thereby, and controls the opening and closing of head intake valve 150, exhaust valve 154, and sidewall intake valve 160 based on various engine and operating parameters provided by a plurality of sensors 180, such as engine torque, engine speed (rpm), and a crank angle of piston 120, for example. Any number of sensors sensing any number of different parameters may be employed as inputs to controller 170 to be used in determining when to switch between 4-cycle and 2-cycle operation, to determine the timing of the opening and closing of head intake valve 150 and exhaust valve 154 when operating in 4-cycle mode (sidewall intake valve 160 remains closed during 4-cycle operation), to determine the timing of the opening and closing of sidewall intake valve 160 and exhaust valve 154 when operating in 2-cycle mode (head intake valve 150 remains closed during 2-cycle operation), and to determine the pressure of intake air 146, for example, during the operation of selective cycle engine 100.

Although illustrated in FIGS. 1A and 1B as employing only a single sidewall intake valve 160, in other examples, selective-engine 100 may employ multiple sidewall intake valves 160 positioned at different vertical positions on sidewall 114 over the stroke length of piston 120 as measured from a bottom dead center (BDC) position of piston 120 to a top dead center (TDC) position of cylinder 120. For instance, as will be illustrated in example embodiments below, in one implementation, selective-cycle engine 100 employs two sidewall ports 140 defined at different vertical positions on sidewall 114, with each of the sidewall ports 140 controlled by a corresponding sidewall intake valve. In other example, multiple sidewall ports 140 may be defined at a same vertical height on sidewall 114 but at different locations about the circumference of cylinder 110.

Several example implementations and operational simulations of selective-cycle engine 100, in accordance with the present disclosure, are illustrated and described below by FIGS. 3-17. It is noted that any number of other implementations are possible without departing from the scope and teachings of the present disclosure.

### EXAMPLE IMPLEMENTATION NO. 1:

FIGS. 3-9 generally illustrate a selective-cycle engine 100-1 according to an Example Implementation No. 1. It is noted that elements similar to those illustrated by FIGS. 1A and 1B are labeled with the same identifiers in FIGS. 3-9. Example Implementation No. 1 may be employed in both spark-ignited (SI) engines and compression-ignited (CI) engines (diesel engines) having conventional compression ratios. As used herein, the term conventional compression ratio is generally within a range of 9-14 for spark-ignited engines and a range of 16-24 for diesel engines.

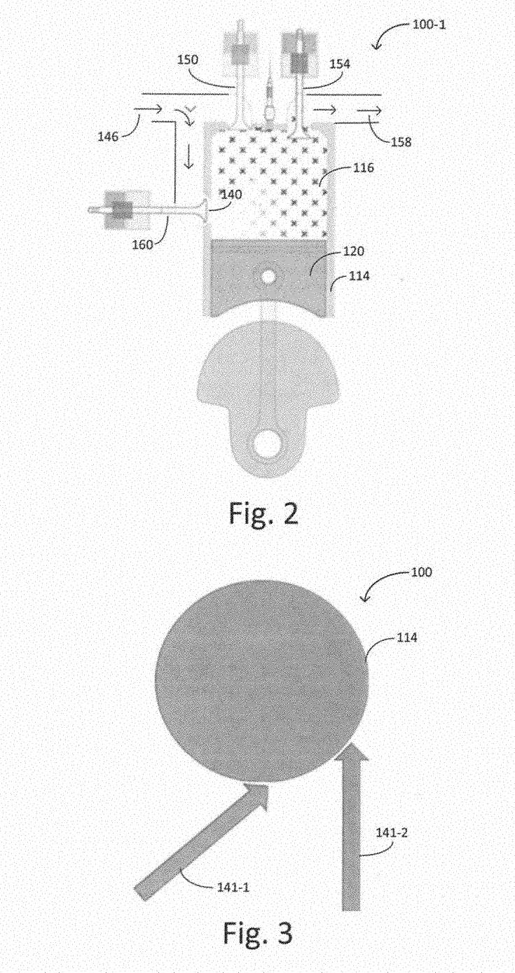

FIG. 2 is a cross-sectional view generally illustrating an example of selective-cycle engine 100-1 in accordance with Example Implementation No. 1 of the present disclosure. According to the illustrated example, selective-cycle engine 100-1 includes a head intake valve 150, an exhaust valve 154, and one or more sidewall intake valves 160 (only one illustrated in FIG. 2). In one example, as illustrated, sidewall intake valve 160 is a poppet valve. According to Example Implementation No. 1, sidewall intake valve 160 is positioned on sidewall 114 in approximately a lower one-half (e.g., 0-50%) of the stroke length 121 as measured from BDC (see FIG. 1B). With reference to FIG. 3, the one or more sidewall intake valves 160 and corresponding sidewall ports 140 are arranged so as to create intake air flows 141-1 and 141-2 which are tangential to a radius of cylinder 110 to create a vortex (a high swirl bulk air motion) in the interior 116 of cylinder 110. Compressed intake air flow 146 is provided by air source 144 (see FIGS. 1A and 1B) which, according to examples, may comprise an electrically boosted device (E-Boost) such as an electrically powered compressor or an electrically assisted supercharger, for example, or a conventional supercharger, a turbocharger, or stored compressed air. In one example, the pressure of intake air 146 is approximately 10-30 psi for sidewall intake valves 150, and in a range from approximately 10-20 bar if pneumatic injectors are used as sidewall intake valves 150. As described below, Example Implementation No. 1 enables an engine downsizing of approximately 30-40% (e.g., a conventional 2.0 Liter engine can be replaced with a 1.4-1.2 Liter engine in accordance with Example Implementation No. 1.)

According to one example, in operation, selective cycle engine 100-1 operates in a 4-stroke mode until controller 170 determines that an engine power request exceeds that of 4-stroke capability, at which point controller 170 switches selective cycle engine 100-1 from 4-stroke mode to 2-stroke mode by disabling the head intake valve 150 and activating the sidewall valve(s) 160 to create a uniflow 2-stroke operation (where uniflow is defined as the fresh air charge from sidewall valve(s) 160 and combustion residuals flowing in the same direction to exhaust port 134).

According to one example of 2-stroke operation, operations of exhaust valve 154 and sidewall valve(s) 160 are timed by controller 170 to optimize scavenging (i.e., the discharging combustion residuals by piston 120) and trapped air mass (i.e., where trapped air mass is defined as the air enclosed within the cylinder for compression and combustion). In one example, such operation includes first opening exhaust valve 154 and then sidewall valve(s) 160 before piston 116 reaches BDC, with the elevated pressure of intake air 146 (e.g., 10-30 psi) forming a rising vortex to push combustion residuals out of cylinder 110 via exhaust port 134 (a so-called “scavenging” event). Exhaust valve 154 is closed when combustion residuals are cleared (or nearly cleared) from cylinder 110 (exhaust valve closing (EVC) is a function of engine speed and load). In one example, sidewall valve 160 is closed based on a desired amount of trapped air mass. As employed herein, EVC is the time for exhaust valve closing. This is the point at which the exhaust valve goes to zero lift.

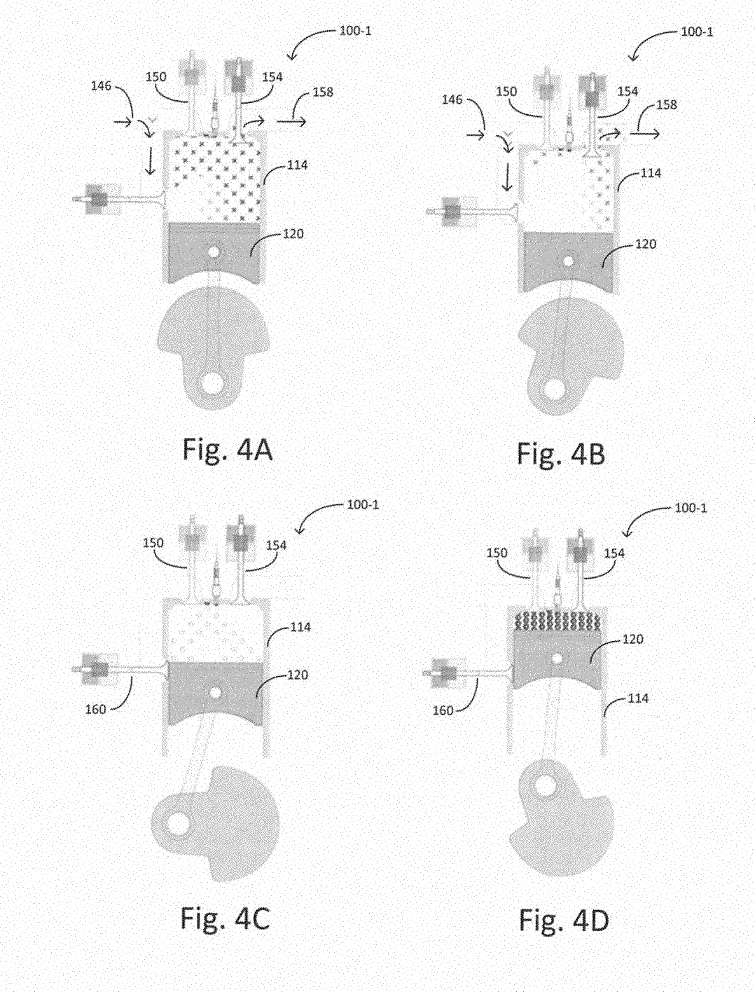

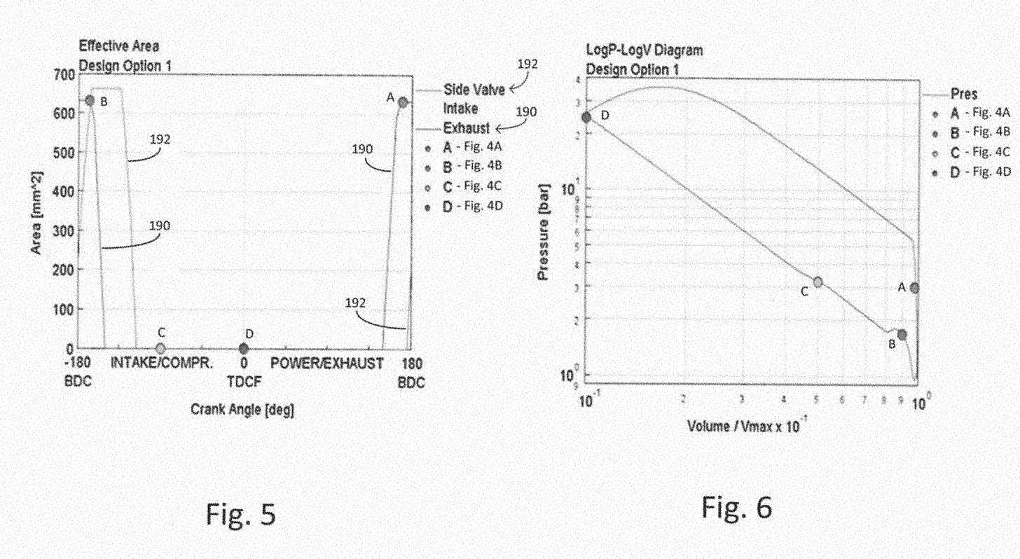

FIGS. 4-7 illustrate a simulated 2-stroke operation of an engine 100-1 according to Example Implementation No. 1, which is similar to that described above, and where engine 100-1 is a spark ignited (SI) engine employing a single sidewall valve 160, in accordance with the present disclosure. FIGS. 4A-4D generally illustrate positions of exhaust and sidewall valves 154 and 160 with piston 120 at different crank angles during a 2-cycle operation of engine 100-1. FIG. 5 is a graph illustrating an example of the opening and closing of exhaust valve 154 and sidewall intake valve 160 in terms of millimeters of effective area during 2-cycle operation, with plot 190 representing the exhaust valve 154 and plot 192 representing the sidewall valve 160. FIG. 6 is a graph illustrating air pressure versus volume/Vmax within cylinder 110 during 2-cycle operation (where it is noted that pressure and volume are both in logarithmic scale).

FIGS. 4A generally illustrates the beginning of a blowdown operation of engine 100-1 just prior to piston 120 reaching BDC, with FIG. 4A corresponding to point “A” in the graphs of FIGS. 5 and 6. FIG. 4B generally illustrates a scavenging portion of the 2-cycle operation as piston 120 begins moving from BDC toward TDC, with FIG. 4B corresponding to point “B” in the graphs of FIGS. 5 and 6.

FIG. 4C generally illustrates a compression portion of the 2-cycle operation as piston 120 moves toward the TDC position, with FIG. 4C corresponding to point “C” in the graphs of FIGS. 5 and 6. FIG. 4D generally illustrates the start of the combustion/power portion of the 2-cycle operation as the fuel air mixture is ignited, and corresponds to point “D” in the graphs of FIGS. 5 and 6.

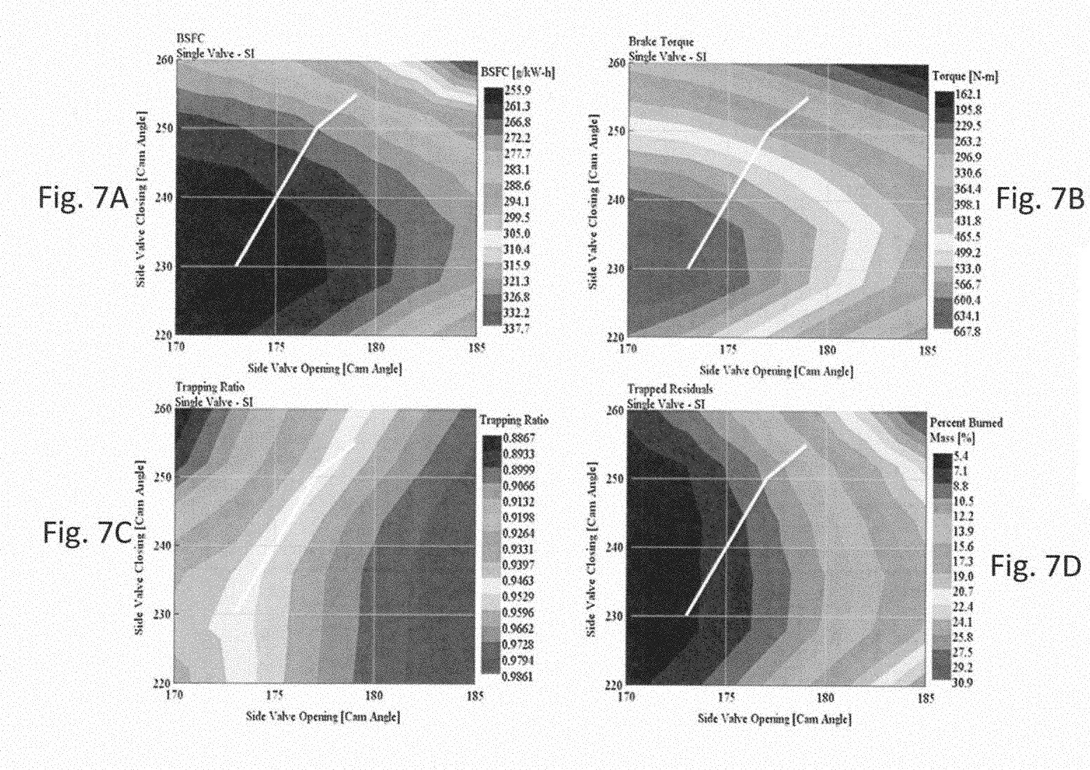

FIGS. 7A-7D are contour maps of several operating metrics of the simulated operation of the engine 100-1 described by FIGS. 4-6 above. In each contour map, the white line represents an example operating strategy for engine 100-1. FIG. 7A is a contour map of the Brake Specific Fuel Consumption (BSFC) with the value of 255.9 g/kW-h corresponding to the lower left of the contour map (at a terminus of the white line), and the value of 337.7 g/kW-h corresponding to the upper right of the plot. FIG. 7B is a contour map of Brake Torque with the value of 162.1 N-m corresponding to the upper right of the contour map, and the value of 667.8 N-m corresponding to the lower left side of the contour map (at a terminus of the white line).

FIG. 7C is a contour map of the Trapping Ratio (defined as the ratio of trapped air mass to delivered air mass) with the value 0.8867 corresponding to the upper left corner of the contour map, and the value of 0.9861 corresponding generally to the lower right side of the contour map. FIG. 7D is a contour map of Trapped Residuals (where the term trapped residuals is defined as the mass of trapped exhaust gas from the previous cycle divided by the overall trapped gas mass) with the value of 5.4 corresponding generally to the left side of the contour map, the value of 30.9 corresponding to the upper right corner, and the value of 24.1 corresponding to the lower right corner.

In general, the metrics illustrated by the contour maps of FIGS. 7A-7D are a function of the opening and closing times of sidewall intake valve 160 and exhaust valve 154, including the trapped conditions (trapping ratio and trapped residuals) being based on timing of sidewall intake valve 160. Although FIGS. 4-7 of Example Implementation No. 1 illustrate operation of a spark-ignited engine, a gas exchange strategy is similar for diesel operation, with torque being controlled via injected fuel mass rather than trapped air mass.

### EXAMPLE IMPLEMENTATION NO. 1A:

FIG. 8 generally illustrates a selective-cycle engine 100-1A, according to Example Implementation No. 1A. A single sidewall valve 160 positioned in a lower portion of the stroke length 121, according to Example Implementation No. 1, may not have enough time to fill cylinder 110 with adequate air volume when an engine is operating at high RPM. With this in mind, engine 100-1A of Example Implementation 1A is similar to that of Example Implementation 1, but includes multiple sidewall intake valves 160 (e.g., two sidewall intake valves), with a second sidewall intake valve positioned vertically higher on sidewall 114, such as between 50% and 70% of the stroke length 121 (as measured from BDC). In one example, a lower of the two sidewall intake valves is position between 0-50% of the stroke length, and an upper of the two sidewall intake valves is positioned between 50-70% of the stroke length. Multiple sidewall intake valves 160, together with higher vertical positioning on sidewall 114, enables complete filling of cylinder 110 with fresh intake air 146 when engine 100-1A of Example Implementation 1A is operating at a higher RPM than engine 100-1 of Example Implementation 1.

### EXAMPLE IMPLEMENTATION 1B:

Example Implementation 1B is not illustrated, but is similar to Example Implementation 1, where a single sidewall intake valve 160 is positioned in a lower one-half of the stroke length 121 (e.g., 0-50% of stroke length 121 as measured from BDC). However, in contrast to Example Implementation 1, air source 144 (see FIGS. 1A and 1B) provides higher pressure intake air 146, such as up to 30 psi, for instance (e.g., 10-30 psi). A higher “boost” pressure on intake air 146 enables an engine according to Example Implementation No. 1B to operate at higher engine speeds (higher RPMs) while using only single sidewall intake valve 160.

### EXAMPLE IMPLEMENTATION NO. 2:

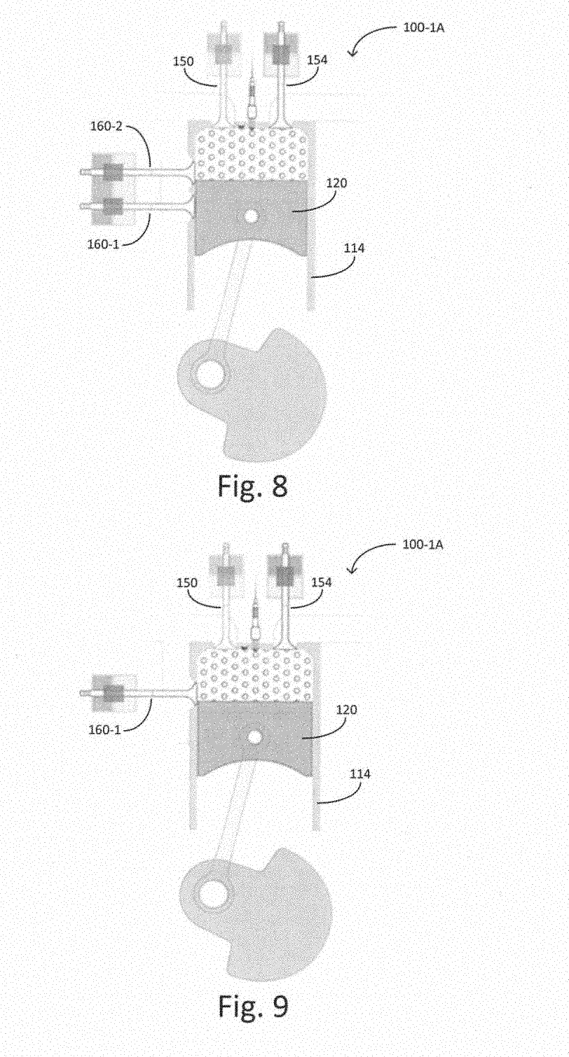

FIGS. 9-13 generally illustrate 2-stroke operation of an engine 100-2 according to an Example Implementation No. 2. It is noted that elements similar to those illustrated by FIGS. 1A and 1B are labeled with the same identifiers in FIGS. 9-13. Example Implementation No. 2 describes a 2-stroke operation of a spark-ignited (SI) selective-cycle engine having an elevated compression ratio, such as a compression ratio in a range of 14:1 to 21:1 (relative to SI engines having conventional compression ratios, such as less that 14:1).

FIG. 9 is a cross-sectional view generally illustrating an example of SI selective-cycle engine 100-2 in accordance with Example Implementation No. 2 of the present disclosure. Selective engine 100-2 includes a head intake valve 150, an exhaust valve 154, and one or more sidewall intake valves 160 (only one illustrated in FIG. 2). In one example, as illustrated, sidewall intake valve 160 is a poppet valve. According to Example Implementation No. 2, sidewall intake valve 160 is disposed at a mid-level position on sidewall 114. In one example, sidewall intake valve 160 is disposed on sidewall 114 in a range of 40-60% of the stroke length 121 as measured from BDC (see FIG. 1B).

With reference to FIG. 3, the one or more sidewall intake valves 160 and corresponding sidewall ports 140 are arranged so as to create intake air flows 141-1 and 141-2 which are tangential to a radius of cylinder 110 to create a vortex (a high swirl bulk air motion) in the interior 116 of cylinder 110. Compressed intake air flow 146 is provided by air source 144 (see FIGS. 1A and 1B) which, according to one example, may comprise an E-Boost device, a turbocharger, or stored compressed air.

According to one example, in operation, selective cycle engine 100-2 operates in a 4-stroke mode until controller 170 determines that an engine power request exceeds that of 4-stroke capability, at which point controller 170 switches selective cycle engine 100-2 from 4-stroke mode to 2-stroke mode by disabling the head intake valve 150 and activating the sidewall valve(s) 160 to create a uniflow 2-stroke operation, with sidewall intake valve(s) 160 and exhaust valve 154 being timed to optimize scavenging. In examples, as will be illustrated below, exhaust valve 154 opens before piston 120 reaches BDC to enable a blowdown event, and sidewall intake valve 160 opens approximately in the middle of a compression stroke and closes at approximately one-half swept volume of the cylinder, where late closing of sidewall intake valve 160 prevents knocking conditions in the cylinder (where “knocking” refers to spontaneous reaction of fuel air mixture in the cylinder usually occurring near the end of the combustion event). In one example, exhaust valve 154 closes when most residuals are cleared from the interior 116 of cylinder 110, where such early-valve-closing (EVC) is a function of engine speed and load.

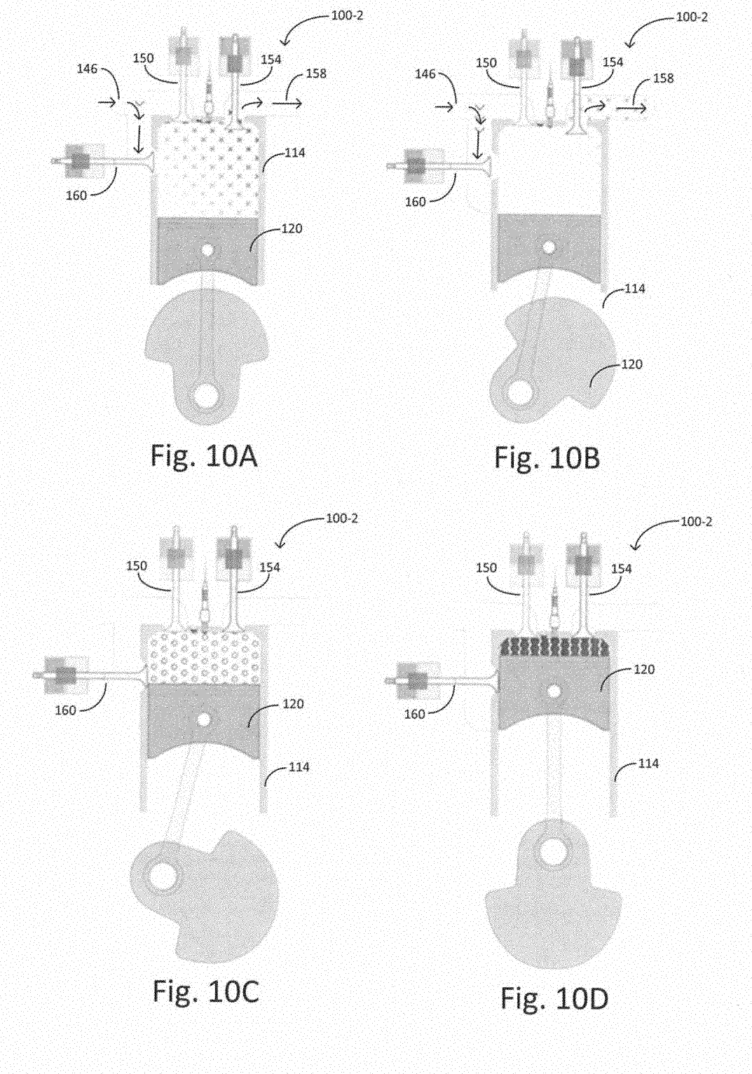

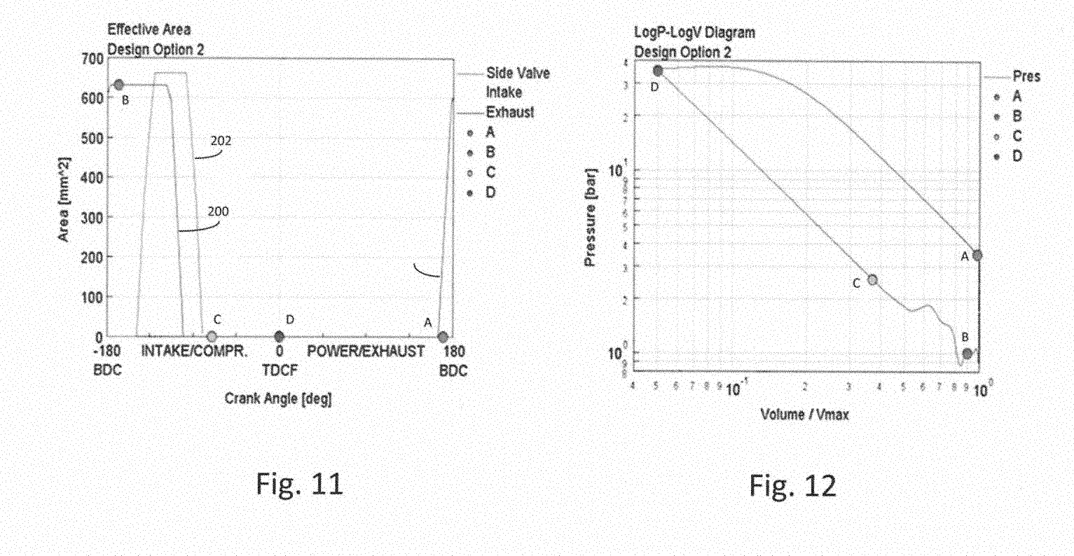

FIGS. 10-13 illustrate an example of a simulated 2-stroke operation of engine 100-2, such as illustrated by FIG. 9. FIGS. 10A-10D generally illustrate positions of exhaust and sidewall valves 154 and 160 with piston 120 at different crank angles during a 2-cycle operation of engine 100-2. FIG. 11 is a graph illustrating an example of the opening and closing of exhaust valve 154 and sidewall intake valve 160 in terms of millimeters of effective area during 2-cycle operation, with plot 200 representing the exhaust valve 154 and plot 202 representing the sidewall valve 160. Figure12 is a graph illustrating air pressure versus volume/Vmax within cylinder 110 during 2-cycle operation (where it is noted that pressure and volume are both in logarithmic scale).

FIGS. 10A generally illustrates the beginning of a blowdown operation of engine 100-2 just prior to piston 120 reaching BDC, with FIG. 10A corresponding to point “A” in the graphs of FIGS. 11 and 12. FIG. 4B generally illustrates a scavenging portion of the 2-cycle operation as piston 120 begins moving from BDC toward TDC, with FIG. 10B corresponding to point “B” in the graphs of FIGS. 11 and 12.

FIG. 10C generally illustrates a compression portion of the 2-cycle operation as piston 120 moves toward the TDC position, with FIG. 10C corresponding to point “C” in the graphs of FIGS. 11 and 12. FIG. 10D generally illustrates the start of the combustion/power portion of the 2-cycle operation as the fuel air mixture is ignited with piston 120 at TDC, and corresponds to point “D” in the graphs of FIGS. 11 and 12.

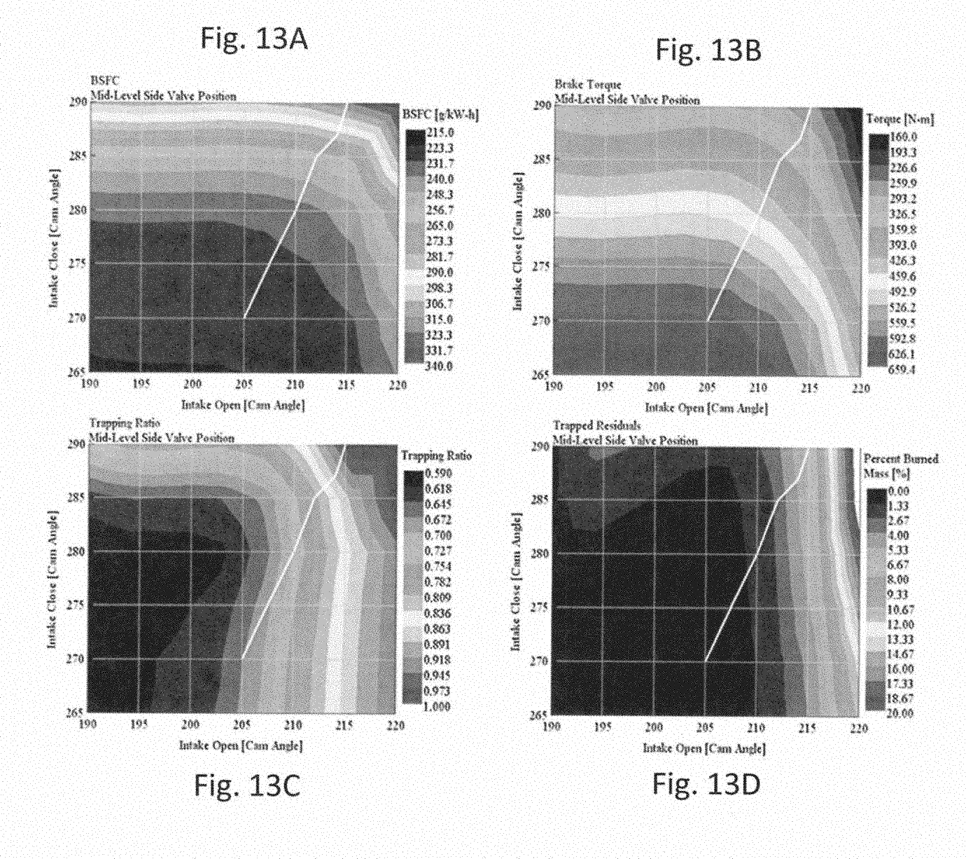

FIGS. 13A-13D are contour maps of several operating metrics of the simulated operation of the engine 100-2 described by FIGS. 10-12 above. In each contour map, the white line represents an example operating strategy for engine 100-2. FIG. 13A is a contour map of the Brake Specific Fuel Consumption (BSFC) with the value of 215.0 g/kW-h corresponding to the lower left of the contour map (at a terminus of the white line), and the value of 340.0 g/kW-h corresponding to the upper right of the plot. FIG. 13B is a contour map of Brake Torque with the value of 160.0 N-m corresponding to the upper right of the contour map, and the value of 659.4 N-m corresponding to the lower left side of the contour map (at a terminus of the white line).

FIG. 13C is a contour map of the Trapping Ratio, with the value 0.590 corresponding generally to the lower left portion of the contour map, and the value of 1.000 corresponding to the upper right corner of the contour map. FIG. 13D is a contour map of Trapped Residuals, with the value of 0.0 corresponding generally to the lower left quadrant of the contour map, 20.0 corresponding to the upper right corner of the contour map.

### EXAMPLE IMPLEMENTATION NO. 2A:

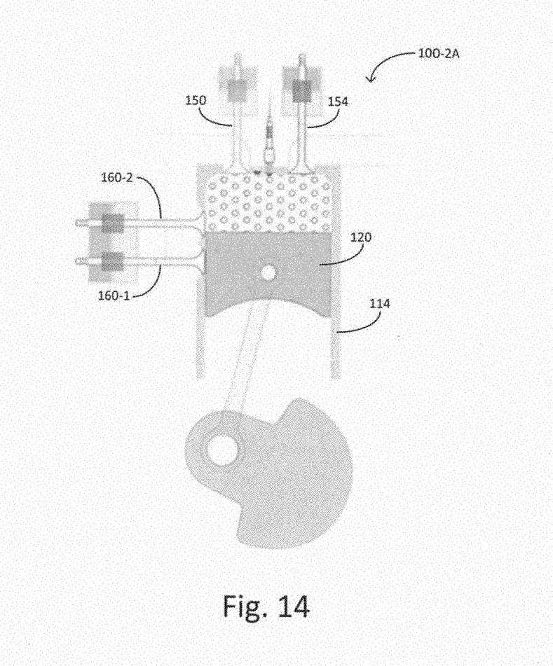

FIG. 14 generally illustrates a selective-cycle engine 100-2A, according to Example Implementation No. 2A. Eengine 100-1A of Example Implementation 2A is similar to that of Example Implementation 2, but includes multiple sidewall intake valves 160 (e.g., two sidewall intake valves) positioned on a lower portion sidewall 114, such as between 0% and 30% of the stroke length 121 (as measured from BDC), for instance. In one example, the lower of the two sidewall intake valves 160 assists in scavenging at all engine speeds, but particularly at higher engine speeds (such as above 4500 RPM, for instance, with the upper side wall valve providing fresh air at higher engine speeds). A brief input of fresh air flow 146 via the lower sidewall intake valve 160 assists in pushing combustion residuals from cylinder 110 via exhaust valve 154. The timing of the opening and closing of the upper sidewall intake valve 160 is primarily responsible for controlling overall trapped air mass in cylinder 110.

### EXAMPLE IMPLEMENTATION NO. 2B:

Example Implementation 2B is not illustrated, but is similar to Example Implementation 2, with a single sidewall intake valve 160 disposed at a mid-level position of sidewall 114, such as between 40-60% of stroke length 121 as measured from BDC. However, in contrast to Example Implementation 2, air source 144 (see FIGS. 1A and 1B) provides higher pressure intake air 146, such as between 10-30 psi, for example. A higher “boost” pressure on intake air 146 enables engine 100-2B of Example Implementation No. 2B to operate at higher engine speeds (higher RPMs) while using only a single sidewall intake valve 160.

### EXAMPLE IMPLEMENTATION NO. 3

Example Implementation is not explicitly illustrated, but relates to 4-stroke, “over-compression” operation of a spark-ignited engine, with such operation providing increased efficiency over 4-stroke operation of engines operating at standard compression ratios (e.g., less than 14:1) employing EIVC (early intake valve closing) or LIVC (late intake valve closing) strategies. According to one example, an engine according to Example Implementation No. 3 has a geometric compression ratio which is fixed at a value in a range between 14:1 to 21:1, where the engine is either not downsized or is slightly downsized (relative to conventional engines with similar power ratings). In one example, sidewall intake valves 160 of an engine according to Example Implementation No. 3 may be positioned at one or more vertical positions and at one or more radial positions about the circumference of sidewall 114 of cylinder 110. During 4-stroke operation, an engine according to Example Implementation No. 3 employs a late-intake-valve-closing (LIVC) or early-intake-valve-closing (EIVC) strategies to limit trapped air mass and avoid knock conditions.

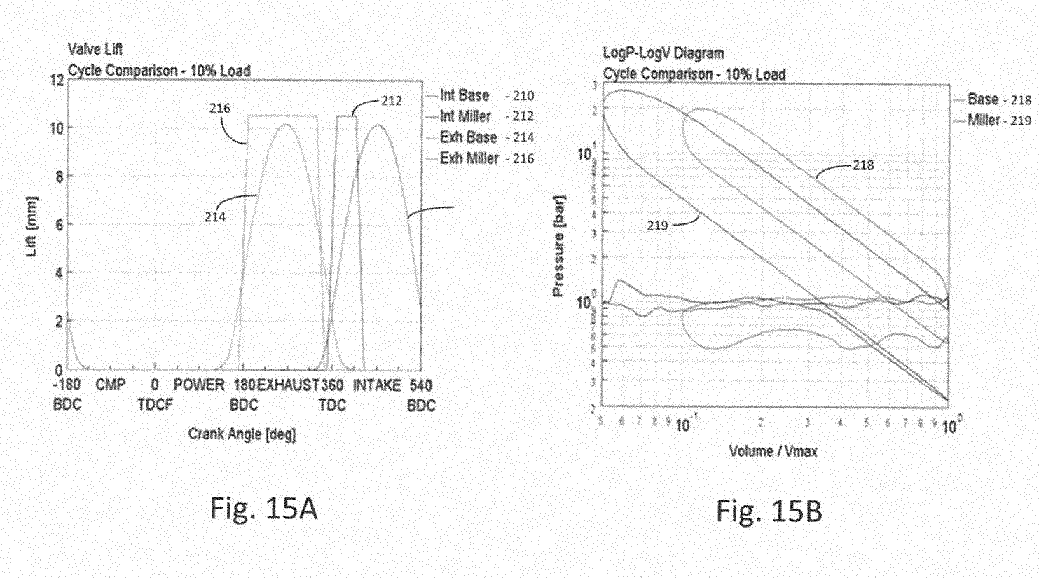

FIGS. 15-17 are graphs respectively illustrating the valve lift timing and pressure for 4-stroke operation of an example engine, according to Example Implementation No. 3, at 10%, 25%, and 50% loading.

FIG. 15A is a graph illustrating 4-stroke valve lift at 10% load, with curve 210 representing “Intake Valve Base”, curve 212 representing “Intake Valve Miller”, curve 214 representing “Exhaust Valve Base”, and curve 216 representing “Exhaust Valve Miller”. FIG. 15B is a graph illustrating engine pressure (LogP vs. LogV) at 10% load, with curve 218 representing “Base”, and curve 219 representing “Miller”.

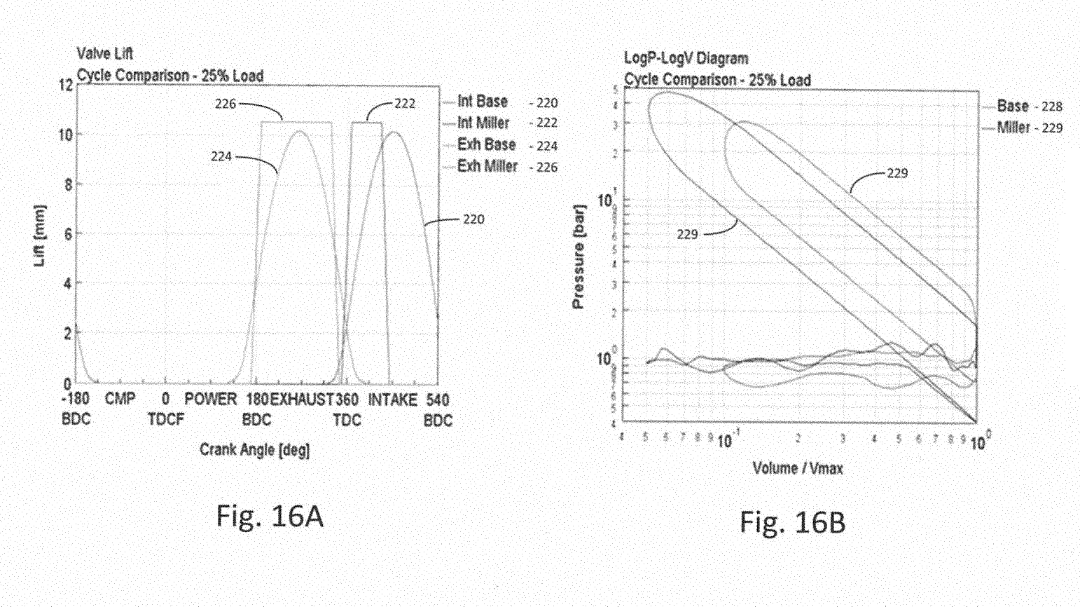

FIG. 16A is a graph illustrating 4-stroke valve lift at 10% load, with curve 220 representing “Intake Valve Base”, curve 222 representing “Intake Valve Miller”, curve 224 representing “Exhaust Valve Base”, and curve 226 representing “Exhaust Valve Miller”. FIG. 16B is a graph illustrating engine pressure (LogP vs. LogV) at 10% load, with curve 228 representing “Base”, and curve 229 representing “Miller”.

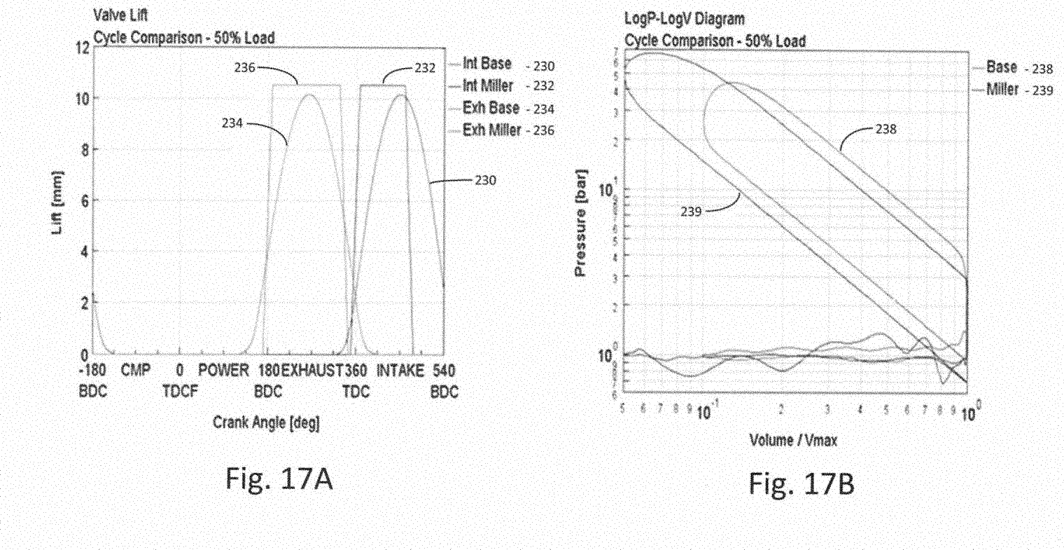

FIG. 17A is a graph illustrating 4-stroke valve lift at 10% load, with curve 230 representing “Intake Valve Base”, curve 232 representing “Intake Valve Miller”, curve 234 representing “Exhaust Valve Base”, and curve 236 representing “Exhaust Valve Miller”. FIG. 17B is a graph illustrating engine pressure (LogP vs. LogV) at 10% load, with curve 238 representing “Base”, and curve 239 representing “Miller”.

According to Example Implementation No. 3, with slight, or no, engine downsizing, during 4-stroke operation, a compression ratio of cylinder 110 may be increased to a range from 14:1 to 21:1, while an EIVC or LIVC strategy may be implemented to underfill the cylinder to avoid engine knock. While such an approach would normally lower a power density of an engine (where power density is defined as power output divided by engine displacement), a selective-cycle engine according to Example Implementation No. 3, in accordance with the present disclosure, may switch from 4-stroke operation to a uniflow 2-stroke mode of operation when power requirements dictate (i.e., when increased power is required). According to Example Implementation No. 3, over-expansion may provide increases of over 10% in thermal efficiency.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A selective-cycle engine selectively operable in a 2-cycle mode and a 4-cycle mode, comprising:
a cylinder including a head portion and a sidewall defining a cylinder interior;
a piston driven in a reciprocating fashion within the cylinder interior;
a head intake port and an exhaust port each defined in the head portion;
a first sidewall intake port defined in the sidewall;
an exhaust valve operable to open and close the exhaust port;
a head intake valve operable to open and close the head intake port; and
a first sidewall intake valve operable to open and close the first sidewall intake port, the head intake valve maintained in a closed position to close the head intake port during 2-cycle mode while the first sidewall intake valve is opened and closed to provide intake air to the cylinder interior with opening and closing of the first sidewall intake valve being separately controlled from reciprocal movement of the piston.

2. The selective-cycle engine of claim 1, wherein the first sidewall intake valve is flush with the cylinder sidewall when in the closed position.

3. The selective-cycle engine of claim 1, the first sidewall intake valve comprising a pneumatic injector.

4. The selective-cycle engine of claim 1, the first sidewall intake valve comprising a pop-up valve including a valve head moveable between an open position and a closed position for opening and closing the first sidewall intake port, the valve head positioned flush with the sidewall when in the closed position and positioned external to the cylinder interior when in the open position.

5. The selective cycle engine of claim 1, including:
a second sidewall intake port vertically positioned on the sidewall between the first sidewall intake port and the head portion of the cylinder; and
a second sidewall intake valve operable to open and close the second sidewall intake port during 2-cycle mode.

6. The selective cycle engine of claim 5, the second sidewall intake port to assist in providing combustion air.

7. The selective cycle engine of claim 1, including an air source providing pressurized air having an air pressure that varies based on engine operating speed to the head intake port and to the first sidewall intake port.

8. The selective cycle engine of claim 6, wherein the air source comprises one of a turbo charger, an electric turbocharger/supercharger, and a compressed air storage tank.

9. A selective-cycle engine selectively operable in a 2-cycle mode and a 4-cycle mode, comprising:
a cylinder including a head portion and a sidewall defining a cylinder interior;
a piston driven in a reciprocating fashion within the cylinder interior;
a head intake port and an exhaust port each defined in the head portion, a sidewall intake port defined in the sidewall;
an exhaust valve operable to open and close the exhaust port;
a first intake valve operable to open and close the head intake port; and
a second intake valve operable to open and close the sidewall intake port, the first intake valve maintained in a closed position to close the head intake port during 2-cycle mode while the second intake valve is opened and closed to provide intake air to the cylinder interior, the second intake valve being flush with the cylinder sidewall when in the closed position.

10. The selective-cycle engine of claim 9, where the second intake valve is positioned external to the cylinder interior when in the open position.

11. The selective cycle engine of claim 10, the second intake valve comprising a pneumatic injector.

12. The selective cycle engine of claim 10, the second intake valve comprising a pop-up valve including a valve head, the valve head positioned flush with the cylinder sidewall when the pop-up valve is in the closed position and positioned external to the cylinder interior when the pop-up valve is in the open position.

13. The selective cycle engine of claim 9, the opening and closing of the first sidewall intake valve being separate from reciprocal movement of the piston.

14. A spark ignited selective-cycle engine selectively operable in a 2-cycle mode and a 4-cycle mode, comprising:
a cylinder including a head portion and a sidewall defining a cylinder interior;
a piston driven in a reciprocating fashion within the cylinder interior, the piston and cylinder having a fixed geometric compression ratio in a range from 14:1 to 21:1;
a head intake port and an exhaust port each defined in the head portion;
a first sidewall intake port defined in the sidewall;
an exhaust valve operable to open and close the exhaust port;
a head intake valve operable to open and close the head intake port; and
a first sidewall intake valve operable to open and close the first sidewall intake port.

15. The engine of claim 14, wherein the piston has a stroke length in an axial direction of the cylinder from a top surface of the piston at a bottom dead center (BDC) position to the top surface of the piston at a top dead center (TDC) position, and wherein the first sidewall intake port is located on the cylinder sidewall in a range of 40 to 60 percent of the stroke length as measured from the top surface of the piston at the BDC position.

16. The engine of claim 14, the first sidewall intake valve maintained in a closed position with the head intake valve and exhaust valve operating to provide 4-cycle mode, the head intake valve operating to introduce pressurized air into the cylinder to produce an effective compression ratio less than the static geometric compression ratio and an expansion ratio equal to the static geometric compression ratio.

17. The engine of claim 14, the head intake valve maintained in a closed position with the first sidewall intake valve and exhaust valve operating to provide 2-cycle mode, with opening and closing of the first sidewall intake valve being independent of the piston.

18. The selective cycle engine of claim 17, the first sidewall intake valve operating to introduce pressurized air into the cylinder to produce an effective compression ratio less than the static geometric compression ratio and an expansion ratio equal to the static geometric compression ratio.

19. The selective cycle engine of claim 14, including:
a second sidewall intake port vertically positioned on the sidewall such that the first sidewall intake port is between the second sidewall intake port and the head portion of the cylinder; and
a second sidewall intake valve operable to open and close the second sidewall intake port during 2-cycle mode.

20. The selective cycle engine of claim 19, the second sidewall intake port to assist in providing scavenging of the cylinder interior.

21. The selective cycle engine of claim 14, including an air source providing pressurized air having an air pressure that varies based on engine operating speed to the head intake port and to the first sidewall intake port.

22. The selective cycle engine of claim 21, wherein the air source comprises one of a turbo charger, an electric turbocharger/supercharger, and a compressed air storage tank.

23. A spark ignited selective-cycle engine selectively operable in a 2-cycle mode and a 4-cycle mode, comprising:
a cylinder including a head portion and a sidewall defining a cylinder interior;
a piston driven in a reciprocating fashion within the cylinder interior, the piston having a stroke length in an axial direction of the cylinder from a top surface of the piston at a bottom dead center (BDC) position to the top surface of the piston at a top dead center (TDC) position;
a head intake port and an exhaust port each defined in the head portion;
a sidewall intake port defined in the sidewall, the sidewall intake port located at a position on the cylinder sidewall in a range of 40 to 60 percent of the stroke length as measured from the top surface of the piston at the BDC position;
an exhaust valve operable to open and close the exhaust port;
a first intake valve operable to open and close the head intake port; and
a second intake valve operable to open and close the sidewall intake port.

24. The spark ignited selective cycle engine of claim 23, the piston and cylinder having a geometric compression ratio in a range from 14:1 to 21:1.

25. The spark ignited selective cycle engine of claim 24, the geometric compression ratio is fixed.

26. The spark ignited selective cycle engine of claim 24, the geometric compression ratio is variable.
